(19) United States
(12) Patent Application Publication
(10) Pub. No.: US 2005/0254708 A1
(43) Pub. Date: Nov. 17, 2005

(54) Segmentation of the left ventricle in apical echocardiographic views using a composite time-consistent active shape model

(76) Inventors: Marie-Pierre Jolly, Hillsborough, NJ (US); Nikolaos Paragios, Vincennes (FR); Ramamani Ramaraj, Dayton, NJ (US); Maxime G. Taron, Paris (FR)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/100,715

(22) Filed: Apr. 7, 2005

Related U.S. Application Data
(60) Provisional application No. 60/561,184, filed on Apr. 9, 2004.

(51) Int. Cl. G06K 9/34; G06K 9/00

(52) U.S. Cl. 382/173; 382/128

(57) ABSTRACT

A method for segmenting a portion of a clip is provided. A first active-shape model of the portion is creating in a first state. A second active-shape model of the portion is created in a second state. A combined model for segmenting the portion is generated. The combined model is a linear combination of the first active-shape model and the second active-shape model. An apparatus for segmenting a portion of a clip is further provided. The apparatus includes a modeling means, a first linear combination means, a transformation means, a second linear combination means, and a segmentation means.

### CROSS-REFERENCE TO RELATED APPLICATIONS

This application claims priority to U.S. Provisional Application No. 60/561,184, which was filed on Apr. 9, 2004, and which is fully incorporated herein by reference.

### BACKGROUND OF THE INVENTION

1. Field of the Invention

The present invention relates generally to the field of processor-based imaging, and, more particularly, to segmenting the left ventricle in apical echocardiographic views using a composite time-consistent active shape model.

2. Description of the Related Art

Cardiovascular diseases are a major health concern worldwide. One way to detect cardiovascular disease is to analyze images of various portions of the heart. The left ventricle, and, in particular, the endocardium, is a structure of a particular interest since it performs the task of pumping oxygenated blood to the entire body. Echocardiographic apical views, when processed, can determine the ejection fraction, which is a critical component of the heart function. One way to determine the ejection fraction is by processing a segmentation of the left ventricle in an end-systole frame and an end-diatole frame in an ultrasound clip. While processing a segmentation of the left ventricle in the end-systole and the end-diatole frame could be sufficient to provide the ejection fraction, continuous tracking of the endocardium may further improve diagnosis of heart disease.

Benefits of echocardiographic imaging include portability and low acquisition cost, while limitations of echocardiographic imaging include the presence of low signal-to-noise (“SNR”) ratio. An appropriate segmentation technique should account for the presence of noise (i.e., corrupted data) in echocardiographic images. For example, although model-free segmentation techniques aim at separating the intensity properties of the image entities, they generally fail to cope with noise and speckle in echocardiography. The use of prior knowledge that encodes the geometric form of the structure of interest is a reasonable way to deal with the corrupted data.

Techniques for segmenting the left ventricle in echocardiographic images are varied. Data-driven segmentation does not work very well because ultrasound data is too noisy to yield good segmentation results on its own. Snake and active contours add a smoothness term to the data driven energy function but still do not perform well due to the amount of noise in the data. Level set segmentation cannot be constrained enough to delineate the object correctly. Only model based segmentation are somewhat successful, including deformable models and templates and active shape and appearance models. The data can be analyzed in raw space (the radio frequency signal before begin converted to an image), polar space or Cartesian space. All three methods have advantages and disadvantages. The radio frequency signal is very clean, but it tends to depend too much on the gain level set by the user. The polar space has the advantage of being isotropic, but some shapes that are not star-like cannot be represented in polar space. Finally, all shapes can be represented in Cartesian space, but the space is highly anisotropic. Some segmentation methods use a statistical/Bayesian formulations to analyze the gray levels in the image and are slightly more robust to noise, but cannot handle abnormal responses very well.

### SUMMARY OF THE INVENTION

In one aspect of the present invention, a method for segmenting a portion of a clip is provided. The method includes the steps of (a) creating a first active-shape model of the portion in a first state; (b) creating a second active-shape model of the portion in a second state; and (c) generating a combined model for segmenting the portion, wherein the combined model is a linear combination of the first active-shape model and the second active-shape model.

In another aspect of the present invention, an apparatus for segmenting a portion of a clip is provided. The apparatus includes a modeling means for creating a first active-shape model and a second active-shape model of the portion; a first linear combination means for recovering a first linear combination of the first active-shape model and the second active-shape model; a transformation means for recovering parameters of a similarity transformation between the first linear combination and a corresponding frame of the image; a second linear combination means for recovering a second linear combination of the modes of variation for the first active-shape model and the second active-shape model; and a segmentation means for determining a precise segmentation of the portion using the parameters of the similarity transformation and the second linear combination.

In yet another aspect of the present invention, a program storage device readable by a machine, tangibly embodying a program of instructions executable on the machine to perform method steps for segmenting a portion of a clip is provided. The method includes the steps of (a) creating a first active-shape model of the portion in a first state; (b) creating a second active-shape model of the portion in a second state; and (c) generating a combined model for segmenting the portion, wherein the combined model is a linear combination of the first active-shape model and the second active-shape model.

### BRIEF DESCRIPTION OF THE DRAWINGS

The invention may be understood by reference to the following description taken in conjunction with the accompanying drawings, in which like reference numerals identify like elements, and in which:

FIG. 1 depicts a global registration on the space of implicit representations using mutual information;

FIG. 2 depicts a local registration on the space of implicit representations using free form deformations;

FIG. 3 depicts an endocardium segmentation for apical views for the diastolic frame and the systolic frame; and

FIG. 4 depicts a flow diagram illustrating an exemplary method for segmenting a portion of a clip.

### DETAILED DESCRIPTION OF PREFERRED EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It is to be understood that the systems and methods described herein may be implemented in various forms of hardware, software, firmware, special purpose processors, or a combination thereof. In particular, at least a portion of the present invention is preferably implemented as an application comprising program instructions that are tangibly embodied on one or more program storage devices (e.g., hard disk, magnetic floppy disk, RAM, ROM, CD ROM, etc.) and executable by any device or machine comprising suitable architecture, such as a general purpose digital computer having a processor, memory, and input/output interfaces. It is to be further understood that, because some of the constituent system components and process steps depicted in the accompanying Figures are preferably implemented in software, the connections between system modules (or the logic flow of method steps) may differ depending upon the manner in which the present invention is programmed. Given the teachings herein, one of ordinary skill in the related art will be able to contemplate these and similar implementations of the present invention.

Segmentation of the left ventricle in echocardiographic images can play an important part in diagnosing heart disease. We propose a model-based approach that aims at extracting the left ventricle for each frame of the cardiac cycle in an echocardiographic clip (i.e., an ultrasound clip). A clip or sequence is a series of images over time. The present invention processes the entire echocardiographic clip, as opposed to just two frames (e.g., the ES frame and the ED frame) of the echocardiographic clip.

Given a new frame of the echocardiographic clip showing the endocardium at an unknown state, we postulate that its model can be expressed as a linear combination of the two major models (i.e., ED and ES). We then have to determine the coefficient of this linear combination.

We create two models: one model for the endocardium at end-diastole (“ED”) and another model for the endocardium at end-systole (“ES”). A method of segmentation is considered in two steps. During the first step of the method, a linear combination of the ES model and the ED model is recovered. The linear combination forms a new model. A similarity transformation, which projects the new model to desired image features, is also recovered. During the second step of the method, a linear combination of the modes of variation for the ES model and the ED model is recovered for precise extraction of the endocardium boundaries. The segmentation method is considered in the temporal domain (i.e., each and every frame of the echocardiographic clip are segmented) where constraints are introduced to couple information across frames and to lead to a smooth solution.

Extraction of important primitives (e.g., ventricular walls, valve plane) that are used for initiating the segmentation process is the first step towards automatic 2D+time (i.e., images over time, over a clip, or over a sequence) segmentation. Then, a linear combination of the two average models (i.e., ES and ED), which forms a new model, and the parameters of a similarity transformation between this new model and the corresponding image are incrementally recovered through a robust minimization. It should be noted that such a model space is dynamic. The parameters of the similarity transformation are constrained to be smooth in the temporal domain. Precise endocardium segmentation is determined through a linear combination of the modes of variation that describe the two training sets (i.e., one for the endocardium at ED and one for the endocardium at ES). The linear combination is constrained over time.

In greater detail below, we will address shape registration and modeling of the left ventricle. We will present global segmentation that involves a global transformation between the model-space and the image. We will also consider local refinements.

1. Modeling the Geometric Structure of the Endocardium

Building compact representations from a set of examples is a well studied problem in imaging and vision. The selection of appropriate models for representing all examples of the training set within a common pose is a critical component of building compact representations. Once appropriate models have been selected, it is generally desirable to align all training examples to the same pose. Modeling can then be performed using any of a variety of statistical techniques, as contemplated by those skilled in the art.

1.1 Global Registration, Mutual Information & Implicit Representations

Registration of shapes is an open and challenging problem in general fields of imaging and vision, and, in particular medical image analysis. Registration generally refers to the process of aligning shapes. Registration superposes two shapes so as to minimize the distance between the shapes. Registration can be achieved, for example, using a global transformation and/or a local deformation to move one shape onto the other.

Modeling requires global registration between the samples in the training set and establishment of local correspondences between the samples. Consider a set of ground truths that includes n components is available, [s₁,s₂, . . . ,sₙ]. Global alignment is equivalent to finding parametric transformations Ai between the training set examples and a target shape s such that
i∈[1, . . . n]: Aᵢ(s)=sᵢ (1)
where s is the common pose to be recovered. An emerging technique for representing shapes is through the use of implicit representations. We represent shapes using distance transforms and implicit representations:

$${ϕ}_{i} ( ω ) = \{ \begin{matrix}0 , & ω ∈ {s}_{i} \\ d ( ω , {s}_{i} ) , & otherwise\end{matrix} \qquad ( 2 )$$

where ω is the pixel location and d(ω,si) is the minimum Euclidean distance between this pixel and the shape si.

The selected representation is translation/rotation invariant. Scale variations can be considered to be global illumination changes in the space of distance transforms. Therefore, registration under scale variations is equivalent to matching different modalities that refer to the same structure of interest. Mutual information is an invariant technique according to a monotonic transformation of the two input random variables. The mutual information is based on the global characteristics of the structures of interest. To facilitate the notation used throughout this disclosure, we denote: (i) the source representation φᵢ as f, and (ii) the target representation φ as g.

In the most general case, registration is equivalent to recovering the parameters Θ=(θ₁,θ₂, . . . ,θ_{N}) of a parametric transformation A such that the mutual information between f_{Ω}=f(Ω) and g_{Ω}^{A}=g(A(Θ;Ω)) is maximized for a given sample domain Ω:
MI=(X^{fΩ},X^{g}^{_{Ω}}^{^{A}})=H[X^{fΩ}]+H[X^{g}^{_{Ω}}^{^{A}}]−H[X^{fΩ,g}^{_{Ω}}^{^{A}}] (3)
where H represents the differential entropy. The mutual information. MI represents a measure of uncertainty, variability or complexity, and includes three components: (i) the entropy of the model; (ii) the entropy of the projection of the model given the transformation; and (iii) the joint entropy between the model and the projection that encourages transformations where f explains g. One can use the mutual information MI and an arbitrary transformation (e.g., rigid, affine, homographic, quadratic) to perform global registration that is equivalent to minimizing:

$$\begin{matrix}E ( A ( Θ ) ) = - MI ( {X}^{f Ω} , {x}^{{g}_{Ω}^{A}} ) \\ = - \int {\int }_{{R}^{2}}^{} {p}^{f Ω , {g}_{Ω}^{A}} ( {l}_{1} , {l}_{2} ) log \frac{{p}^{f Ω , {g}_{Ω}^{A}} ( {l}_{1} , {l}_{2} )}{{p}^{f Ω} ( {l}_{1} ) {p}^{{g}_{Ω}^{A}} ( {l}_{2} )} ⅆ {l}_{1} ⅆ {l}_{2}\end{matrix} \qquad ( 4 )$$

where (i) p^{fΩ} corresponds to the probability density in f_{Ω}([φ_{D}(Ω)]) (ii) p^{g}^{_{Ω}}^{^{A}} corresponds to density in g_{Ω}^{A}([φₛ(A(Θ;Ω))]), and (iii) p^{fΩ,g}^{_{Ω}}^{^{A}} is the joint density. The minimization method with global transformation and mutual information criterion can account for various global motion models. We consider similarity registration between the training examples for the endocardium shapes.

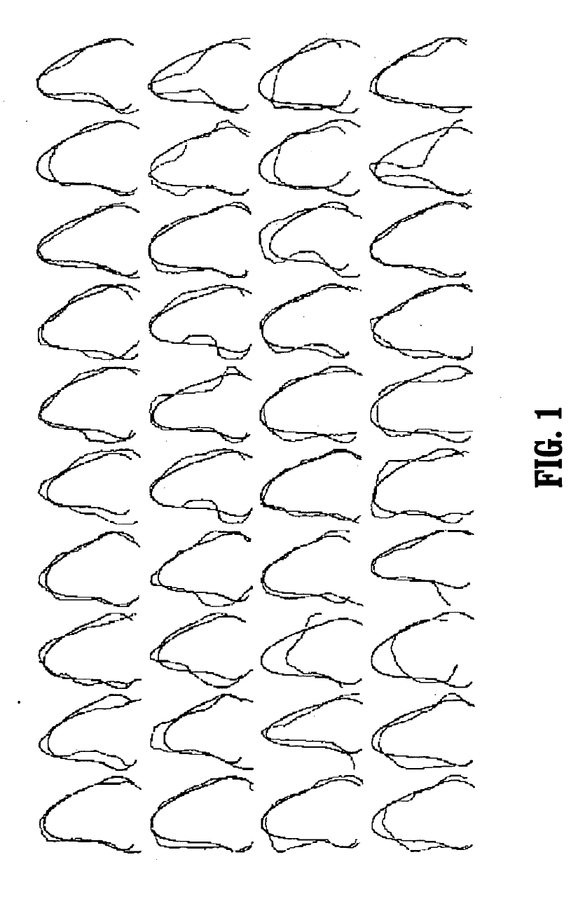

Registration examples for the particular class of endocardium shapes are shown in FIG. 1. FIG. 1 illustrates a global registration on the space of implicit representations using mutual information. Once training examples have been aligned, one should address the problem of recovering point (element)-wise correspondences. A deformation field L(Ω;x) can be recovered either by using standard optical flow constraints or by using any of a variety of warping techniques known to those skilled in the art. An exemplary warping technique is the free form deformations method, which is a common approach in graphics, animation and rendering.

1.2 Local Registration, Free Form Deformations & Implicit Representations

The essence of FFD is to deform an object by manipulating a regular control lattice P overlaid on the object's volumetric embedding space. FFD techniques, which contrast with optical flow techniques, support smoothness constraints, exhibit robustness to noise, and are suitable for modeling large and small non-rigid deformations. Furthermore, under certain conditions, FFD techniques can support a dense registration paradigm that is continuous and guarantees a one-to-one mapping.

Consider an incremental cubic B-spline free form deformation (“FFD”) for modeling the local transformation L. Dense registration is achieved by evolving a control lattice P according to a deformation improvement [δP]. A primary goal is to solve for the parameters of the FFD (or coordinates of the control lattice) so that one shape is deformed onto the other one.

Consider a regular lattice of control points
P_{m,n}=(P_{m,n}^{x},P_{m,n}^{y});m=1, . . . ,M,n=1, . . . ,N (5)
overlaid to a structure
Γ_{c}={x}={(x,y)|1≦x≦X,1≦y≦Y} (6)
in the embedding space that encloses the source structure. Denote the initial configuration of the control lattice as P⁰, and the deforming control lattice as P=P⁰+δP. Under these assumptions, the incremental FFD parameters are the deformations of the control points in both directions (x,y);
Θ={(δP_{m,n}^{x},δP_{m,n}^{y})};(m,n)∈[1,M]×[1,N] (7)
The motion of a pixel x=(x, y) given the deformation of the control lattice from P⁰ to P, is defined in terms of a tensor product of the cubic B-spline:

$$\begin{matrix}L ( Θ ; x ) = x + δ L ( Θ ; x ) \\ = {\sum }_{k = 0}^{3} {\sum }_{l = 0}^{3} {B}_{k} ( u ) {B}_{l} ( v ) ( {P}_{i + k , j + l}^{0} + δ {P}_{i + k , j + l} ) \\ where \\ i = ⌊ \frac{x}{X} • M ⌋ + 1 , j = ⌊ \frac{y}{Y} • N ⌋ + 1 , \\ \begin{matrix}u = \frac{x}{X} M - ⌊ \frac{x}{X} • M ⌋ & and & v = \frac{y}{Y} N - ⌊ \frac{y}{Y} • N ⌋\end{matrix}\end{matrix} \qquad ( 8 )$$

The terms of the deformation component are as follows: (i) δP_{i+1,j+1},(k,l)∈[0,3]×[0,3] includes the deformations of pixel x's (sixteen) adjacent control points; (ii) δL(x) is the incremental deformation at pixel x; and (iii) Bₖ(u) is the k^{th} basis function of a cubic B-spline (Bₗ(v) is similarly defined).

Local registration now is equivalent to finding the best lattice P configuration such that the overlaid structures coincide. Because structures correspond to distance transforms of globally aligned shapes, the sum of squared differences (“SSD”) can be considered as the data-driven term to recover the deformation field L(Θ;x):
E_{data}(Θ)=∫∫_{Ω}(φ_{\hat{D}}(x)−φₛ(L(Θ;x))²dx (9)

The use of such technique to model the local deformation registration component introduces in an implicit form some smoothness constraint that can deal with a limited level of deformation. To further preserve the regularity of the recovered registration flow, one can consider an additional smoothness term on the deformation field δL. Consider a computationally efficient smoothness term:

$${E}_{smoothness} ( Θ ) = \int {\int }_{Ω}^{} ( {‖ \frac{\partial δ ( Θ ; x )}{\partial x} ‖}^{2} + {‖ \frac{\partial δ ( Θ ; x )}{\partial y} ‖}^{2} ) ⅆ x \qquad ( 10 )$$

The smoothness term is based on a classic error norm that has certain known limitations. One can replace this smoothness term with more elaborated norms. Within the energy to be minimized and the definition of the FFD, an implicit smoothness term is also imposed by the spline FFD. Therefore, introducing complex and computationally expensive regularization components is unnecessary.

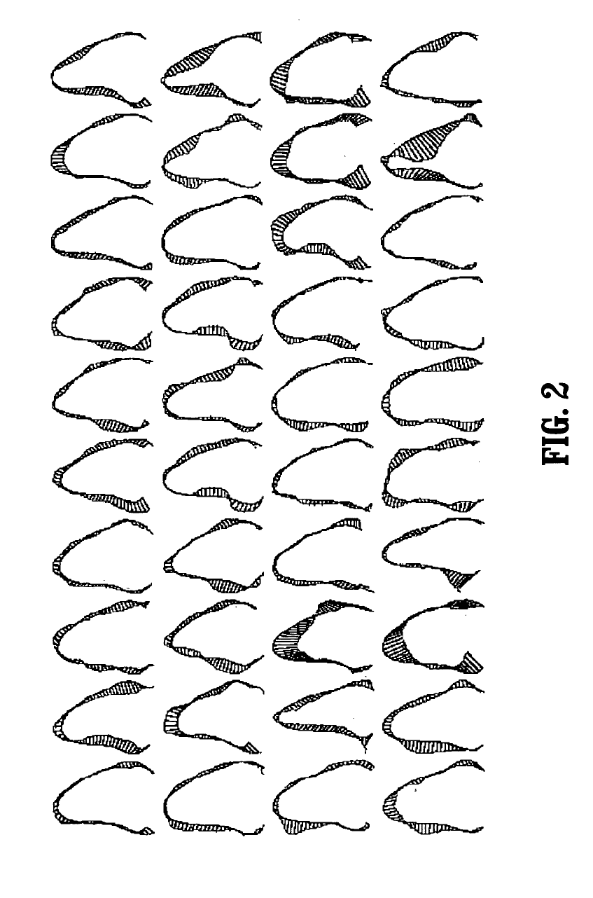

The data-driven term and the smoothness term can now be integrated to recover the local deformation component of the registration and solving the correspondence problem: E(Θ)=E_{data}(Θ)+αEₛₘₒₒₜₕₙₑₛₛ(Θ), where α is the constant balancing the contribution of the two terms. The calculus of variations and a gradient descent method can be used to optimize such objective function E(Θ). The performance of the alignment (or registration) process using global transformation and FFD local deformations on the training set of endocardial contours at end-systole is demonstrated in FIG. 2. FIG. 2 illustrates a local registration on the space of implicit representations using free form deformations.

1.3 Composite Model Building

Consider two sets of ground truths that include n components are available: one for the end-diastole case [d₁,d₂, . . . ,dₙ] and one for the end-systole case [s₁,s₂, . . . ,sₙ]. Without loss of generality, one can assume that the elements of each set include m points defined on the Euclidean plane (dᵢ=(x₁ⁱ,x₂ⁱ, . . . ,xₘⁱ)) and are registered to a common pose.

Principle Component Analysis (“PCA”) can be applied to capture the statistics of the corresponding elements across the training examples. PCA refers to'a linear transformation of variables that retains, for a given number o₁,o₂ of operators, the largest amount of variation within the training data, according to:

$$\begin{matrix}d = \overline{d} + {\sum }_{k = 1}^{{o}_{1}} {λ}_{k}^{d} ( {u}_{k}^{d} , {v}_{k}^{d} ) , & s = \overline{s} + {\sum }_{k = 1}^{{o}_{2}} {λ}_{k}^{s} ( {u}_{k}^{s} , {v}_{k}^{s} )\end{matrix} \qquad ( 11 )$$

where \overline{d} (respectively \overline{s}) refers to end-diastole (respectively end-systole) shape, o₁ and o₂ are the number of retained modes of variation for each model, (uₖ^{d},vₖ^{d}) and (uₖ^{s},vₖ^{s}) are these modes (i.e., eigenvectors) for each model, and λⱼ^{d} and λⱼ^{s} are linear factors within the allowable range defined by the eigenvalues for each model.

Once average models for the end-systole and end-diastole cases are considered, one can further assume that the average models are registered; therefore there is a one-to-one correspondence between the points that define these shapes (i.e., the average (or mean) shape for the end-diastole model and the average shape for the end-systole model). Let (\overline{d}=(x₁^{d},x₂^{d}, . . . ,xₘ^{d})) be the end-diastole average model and (\overline{s}=(x₁^{s},x₂^{s}, . . . ,xₘ^{s})) the end-systole one. Then one can define a linear space of shapes as follows:
\overline{c}(α)=α\overline{s}+(1−α)\overline{d}, 0≦α≦1 (12)
One then can define a linear space of deformations that can account for the end-systole frame, the end-diastole frame, and the frames in between the end-systole frame and the end-diastole frame:

$$c ( α , {λ}_{k}^{d} , {λ}_{s}^{d} ) = \overline{c} ( α ) + {\sum }_{k = 1}^{{o}_{1}} {λ}_{k}^{d} ( {u}_{k}^{d} , {v}_{k}^{d} ) + {\sum }_{k = 1}^{{o}_{2}} {λ}_{k}^{s} ( {u}_{k}^{s} , {v}_{k}^{s} ) \qquad ( 13 )$$

The most critical issue to be addressed within the definition of a model as a linear combination of two models is the registration of the training examples as well as the registration of the end-systole average shapes and the end-diastole average shapes. An exemplary approach proposed in Huang et al., Establishing Local Correspondences Towards Compact Representations of Anatomical Structures, that performs registration in the implicit space of distance functions using a combination between mutual information criterion and a free-form de-formation principle may be used. Such an approach can provide one-to-one correspondences between shapes for any given number of sampling elements. The resulting composite model is of limited complexity, and can account for the end-systole form and the end-diastole form of the endocardium as well as for the frames in between.

1.4 Composite Active Shape Models

Active shapes assume an average model, a certain number of modes of variation, and the existence of corresponding image features. Without loss of generality, one can assume that for each point j on the model space c(α,λₖ^{d},λₛ^{d}) the corresponding image point yⱼ has been recovered. The objective is to recover a set of parameters that will move each point in the model space cⱼ to the corresponding location in the image space yⱼ. Such a task is performed in two stages. In the first stage, a global transformation T (similarity transform in our case) between the model and the image is recovered that minimizes:

$${E}_{data} ( α , T ) = {\sum }_{j = 0}^{m} ρ ( ‖ T ( {\overline{c}}_{j} ( α ) ) - {y}_{j} ‖ ) \qquad ( 14 )$$

according to some metric function ρ where

$$T ( x , y ) = [ \begin{matrix}a & b \\ - b & a\end{matrix} ] [ \begin{matrix}x \\ y\end{matrix} ] + [ \begin{matrix}c \\ d\end{matrix} ] \qquad ( 15 )$$

includes a translation, a rotation, and a scaling component and α is the coefficient of the linear combination as in Eq. (12). The selection of the transformation should be consistent with the one adopted during the learning stage. The learning stage occurred when we aligned all the training examples to build the model. In Eq. (1) and (4), we had a global transformation A. Since we had used a similarity transformation at that time, we are also using a similarity transformation now to segment the current image using the linear combination model (i.e., the linear combination of the two models that we built for ED and ES). It should be noted that the linear combination model is not static because it refers to a linear combination of the end-systole model and the end-diastole model. Therefore, the segmentation process aims to recover simultaneously the combination of these two models that better accounts for the shape of the true data points and the optimal transformation between the linear combination model and the image space.

One can recover the parameters alpha for the linear combination and the parameters of the similarity transformation through an incremental update of the transformation. The corresponding location of the model points in the image plane can be used to improve the segmentation by seeking an incremental update on the transformation T such that the projection of the \overline{c}ⱼ moves closer to its true position yⱼ in the image.

2. Rough Segmentation of the Endocardium

The left ventricle is bounded on each side by the walls that tend to appear brighter in the ultrasound clip due to the various reflections from the tissue. In apical (i.e., both 2 chamber and 4 chamber) views, the left ventricle is bounded on the bottom side by the mitral valve, which connects the left ventricle to the left atrium. The mitral valve is constantly moving (i.e., opening and closing) and its reflections are well recovered by the acquisition process (i.e., the process of acquiring ultrasound images). We consider two parabolic equations to recover a rough approximation/detection of the left ventricle walls which are the areas with the highest brightness. The parabolas model not only the left ventricle walls, but also outline the left atrium. The next step is to extract and track the position of the mitral valve that separates the left ventricle and the left atrium. The approach relies on the observation that if the valve is closed, the two heart chambers are clearly separated, while, if the valve is open, the two heart chambers are connected. Two ellipses are used to model the ventricle and the atrium. The plane that best separates these ellipses and is consistent over time is considered to be the valve plane.

2.1 Recovering Correspondences

The most critical part within the presented framework (i.e., the whole segmentation process to recover the endocardium in all frames of the ultrasound clip) is solving the correspondence problem between the actual projection of the model and the optimal position of the model. Such task within the active shape model is solved using a normalized intensity profile in the normal direction.

We consider a probabilistic formulation of the correspondence problem of finding a point in the image that corresponds to a point in the model, for all points in the model. One would like to recover a density p_{border} that can provide the probability of a given pixel ω being at the boundaries of the endocardium. One can constrain the search in the direction normal to the model projection. The ventricular area includes a blood pool and heart walls. Endocardium border detection is equivalent to finding the boundaries between these two classes.

A description of the statistical properties of the blood pool and the cardiac wall can be recovered. Let p_{wall} be the probability of a given intensity (gray level) being part of the endocardium walls, and let p_{blood} be the density that describes the visual properties of the blood pool. Then correspondences between the model and the image are meaningful in places where there is a transition between the two classes, wall and blood pool, represented by the statistical distributions. Given a local partition, one can define a transition probability between the two classes. Consider two line segments [L(T(xⱼ)),R(T(xⱼ))] originating from T(xⱼ), in the direction T(Nⱼ) normal to the model, and going in opposite directions (L towards the wall and R towards the blood). One can assume that the point of interest is a projection of the model point xⱼ:
p_{border}(T(xⱼ))=p([wall|ω∈L(T(xⱼ))]∩[blood|ω∈R(T(xⱼ))]) (16)
Both sides of the intersection sign can be considered independent, leading to the following form for the border density:

$$\begin{matrix}{p}_{border} ( T ( {x}_{j} ) ) = p ( wall \vert ω ∈ L ( T ( {x}_{j} ) ) p ( blood \vert ω ∈ R ( T ( {x}_{j} ) ) ) \\ = {\prod }_{ω ∈ L} {p}_{wall} ( I ( ω ) ) {\prod }_{ω ∈ R} {p}_{blood} ( I ( ω ) )\end{matrix} \qquad ( 17 )$$

One can evaluate the probability P_{border} (i.e., the probability of a pixel being a border pixel between wall and blood) under the condition that the blood pool and wall density functions are known. A-log function can be used to overcome numerical constraints, which is equivalent to finding the minimum of:

$$E ( ϕ ) = {\sum }_{ω ∈ L ( ϕ )} λ \vert I ( ω ) \vert + {\sum }_{ω ∈ R ( ϕ )} \frac{{( I ( ω ) - μ )}^{2}}{2 {σ}^{2}} \qquad ( 18 )$$

after dropping out the constant terms where the blood pool is modeled using an exponential distribution (λ) and tissue/walls using a Gaussian distribution (μ,σ). Thus, the most probable correspondence is recovered through the evaluation of E(φ) where φ is a point in the line defined by the projected normal. The search space for φ is considered to be all image locations respecting two conditions: (i) live in the normal T(Nⱼ), and (ii) their distance from the current projection T(\overline{c}ⱼ(α)) is within a given search window. Once such correspondences are established, the mechanism presented in section 1.4, above, may be used to determine the optimal solution through the estimation of the parameters of the transformation (αₜ,Tₜ).

2.2 Constraints on the Motion and the Position of the End-Valve Points

The motion of the valve plane is very critical to the operation of the endocardium. Such motion is consistent over time, and quite often exhibits a symmetric form. Without loss of generality, one can assume that the first \overline{c}₀(α) and the last point \overline{c}ₘ(α) of the model correspond to the valve end points. The displacement of these valve end points from one frame to the next can be recovered in an implicit form.

Let (αₜ₋₁,Tₜ₋₁) be the model (coefficient of the linear combination) and its transformation in the previous frame. Then, given some estimates on the current solution (αₜ,Tₜ), one can constrain the implicit motion of the valve points as follows:

$${E}_{valve motion} ( {α}_{t} , {T}_{t} ) = ψ ( \vert {T}_{t - 1} ( {\overline{c}}_{0} ( {α}_{t - 1} ) ) - {T}_{t} ( {\overline{c}}_{0} ( {α}_{t} ) ) \vert ) + ψ ( \vert {T}_{t - 1} ( {\overline{c}}_{m} ( {α}_{t - 1} ) ) - {T}_{t} ( {\overline{c}}_{m} ( {α}_{t} ) ) \vert ) \qquad ( 19 )$$

where ψ is an error metric—the Euclidean distance in this case—Tₜ₋₁(\overline{c}ₘ(αₜ₋₁)) is the position of the valve point at frame t-1, Tₜ(\overline{c}ₘ(αₜ) the corresponding projection at frame t and Tₜ₋₁(\overline{c}ₘ(αₜ₋₁))−Tₜ(\overline{c}ₘ(αₜ)) the displacement of the valve point from one frame to the next. The energy term E_{valve motion} will constrain the motion of the valve plane to be smooth over time. It accounts for the relative motion of the valve points but not for their actual position. To remedy this, one can introduce constraints forcing the model projections of the valve points to be close to the valve-plane earlier recovered (αᵥₐₗᵥₑx+βᵥₐₗᵥₑy+γᵥₐₗᵥₑ=0). The distance between the current positions of the model valve points (\overline{c}₀(α),\overline{c}ₘ(α)) and their projections to the valve-plane (\overline{p}₀(α),\overline{p}ₘ(α)) is a term to be minimized:

$${E}_{valve projection} ( {α}_{t} , {T}_{t} ) = ψ ( \vert {p}_{0} ( t ) - {T}_{t} ( {\overline{c}}_{0} ( {α}_{t} ) ) \vert ) + ψ ( \vert {p}_{m} ( t ) - {T}_{t} ( {\overline{c}}_{m} ( {α}_{t} ) ) \vert ) \qquad ( 20 )$$

One can consider a step further by recovering the exact position of the valve points in the image, and then using these positions during the segmentation process. To this end, a model is built on the image profile for the left and the right end-valve points using an image patch centered at the ground truth position of the valve. Many of these patches are collected as training examples. They are normalized and an average model is recovered. Standard matching techniques are considered within a search area in the vicinity of the projected valve position to recover the most prominent valve points.

2.3 Smoothness Constraints on the Transformation Parameters

The motion of the ventricle also should fulfill certain constraints. The motion must be periodic, exhibit a shrinking between the end-diastole and the end-systole frame, and exhibit an expansion for the last part of the cardiac cycle. Such constraints can be imposed in various forms.

Direct motion constraints, such as the one earlier considered in Eq. (19), focus on the distance of a model point in two consecutive frames. However, such direct motion constraints do not encode the continuity of the model. We consider an implicit form, where continuity is imposed on the parameters of the model (α(t)) and the transformation (T(t)):

$${E}_{smoothness} ( {α}_{t} , {T}_{t} ) = {\sum }_{k = - τ}^{τ} ( ω ( \vert α ( t ) - α ( t + k ) \vert ) + ω {\sum }_{p ∈ T} ω ( \vert p ( t ) - p ( t + k ) \vert ) ) \qquad ( 21 )$$

where p∈T is the set of the similarity transformation parameters (a,b,c,d), ω is a monotonically decreasing function, and [−τ,τ] is the interval where continuity on the rough segmentation parameters is imposed. The term Eₛₘₒₒₜₕₙₑₛₛ will minimize the distance between the parameters of the transformation and the coefficient of the linear combination. This is equivalent to constraining the motion of the endocardium from one frame to the next.

The objective function is minimized using a two-stage robust incremental estimate technique. The calculus of Euler-Lagrange equations with respect to the transformation parameters leads to a 4×4 linear system that has a closed form solution. Once the parameters of the transformation are recovered, the optimal model space a is recovered through an exhaustive search within the [0,1] integral according to some quantization step.

3. Refined Segmentation

Once appropriate models and similarity transformations are recovered for all frames of the cardiac clip, the next step is precise extraction of the endocardium walls. Such a task is equivalent to finding a linear combination of the modes of variation that deforms globally the model projection towards the desired image features. The space of variations includes the end-diastole model and the end-systole model. In contrast to the rough segmentation case where the ED and ES models are linearly combined, the need of a blending parameter between end-systole and end-diastole modes of variation does not exist. Under the assumption of existing correspondences yⱼ and the global transformation (α,T) for a given frame t (omitted from the notation), these linear coefficients are recovered through:

$${E}_{data} ( {λ}_{0}^{d} , … , {λ}_{0}^{s} , … ) = {\sum }_{j = 0}^{m} ρ ( ‖ T ( {\overline{c}}_{j} ( α ) ) + {\sum }_{k = 1}^{{o}_{1}} {λ}_{k}^{d} ( {u}_{k}^{d} , {v}_{k}^{d} ) + {\sum }_{k = 1}^{{o}_{2}} {λ}_{k}^{s} ( {u}_{k}^{s} , {v}_{k}^{s} ) - {y}_{j} ‖ ) \qquad ( 22 )$$

Similar to the case of global transformation, one can assume now that the form of the ventricle changes gradually during the cardiac cycle. The geometry of the recovered solution is determined according to the set of coefficients (λ₀^{d}, . . . ,λ₀^{s}, . . . ). Therefore, imposing constraints of smoothing deformation from one frame to the next is equivalent to seeking the lowest potential of

$${E}_{smoothness} ( {λ}_{0}^{d} , … , {λ}_{0}^{s} , … ) = {\sum }_{k = - τ}^{τ} ( {\sum }_{l = 1}^{{o}_{1}} ω ( {λ}_{l}^{d} ( t ) - {λ}_{l}^{d} ( t + k ) ) + {\sum }_{l = 1}^{{o}_{2}} ω ( {λ}_{l}^{s} ( t ) - {λ}_{l}^{s} ( t + k ) ) ) \qquad ( 23 )$$

Additional constraints using the position of the valve points could be considered, which aims at moving the projections of the model valve points to the their true positions. The objective function is minimized using a robust incremental estimate technique. The calculus of Euler-Lagrange equations with respect to the unknown variables (λ₀^{d}, . . . ,λ₀^{s}, . . . ) leads to a [o₁+o₂]×[o₁+o₂] linear system that has a closed form solution. The minimization of the energy function from Eqs. 22 and 23 is repeated until convergence.

### 4. CONCLUSIONS

As described in greater detail above, we have proposed a composite time-consistent 2D+time active shape model for the segmentation of the left ventricle in echocardiography. The approach exhibits certain novel elements, such as in the modeling phase and the segmentation phase.

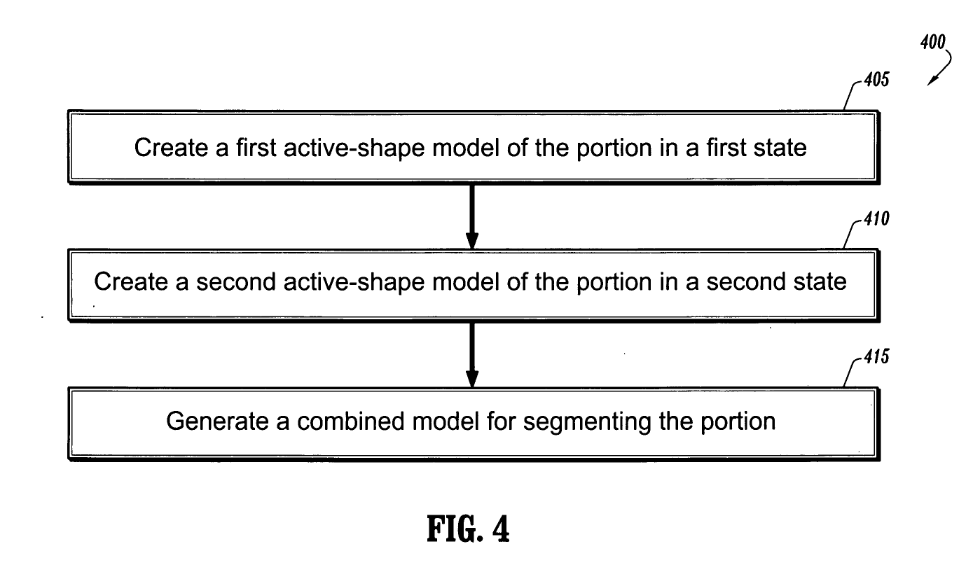

Referring now to FIG. 4, an exemplary method 400 for segmenting a portion of a clip is shown. In one embodiment of the present invention, the clip may be an endocardiographic clip and the portion may be a left ventricle. A first active-shape model of the portion is created (at 405) in a first state. A second active-shape model of the portion is created (at 410) in a second state. As used herein, the term ‘state’ refers to a time instance. A combined model is generated (at 415) for segmenting the portion. The combined model is a linear combination of the first active-shape model and the second active-shape model.

The above-described method can work with any medical imaging modality, as contemplated by those skilled in the art. For example, long axis views of the left ventricle can be viewed in magnetic resonance (MR), instead of ultrasound. Further the above-described method may be used for segmenting any object that undergoes a smooth motion (i.e., deformation) from one extreme to another. Then, each extreme can be modeled with an active-shape model.

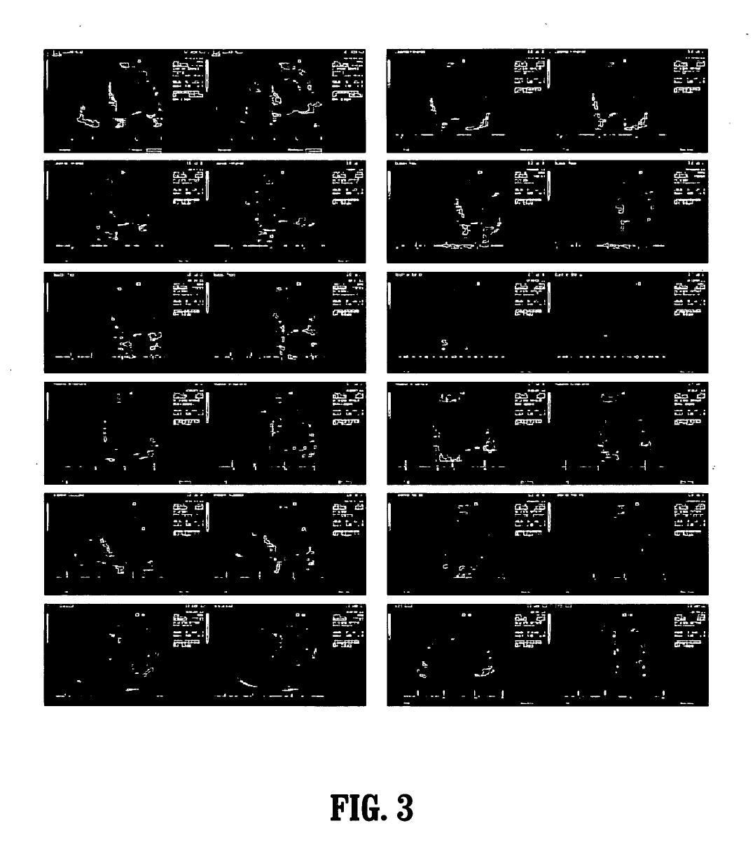

Validation of the method was performed using a representative set of fifty patients for 2 and 4 champers views, as shown in FIG. 3, where the output of the proposed technique is superimposed to the ground truth. FIG. 3 illustrates an endocardium segmentation for apical views for the end-diastole frame and the end-systole frame. The objective was precise delineation of the ventricle, which is a much harder task than estimation of the ejection fraction. Half of the time sonographers accepted the result as it was. For 25% of the test set, minor adjustments, in particular in the valve position, were sufficient to make the solution acceptable.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method for segmenting a portion of a clip, comprising:
(a) creating a first active-shape model of the portion in a first state;
(b) creating a second active-shape model of the portion in a second state; and
(c) generating a combined model for segmenting the portion, wherein the combined model is a linear combination of the first active-shape model and the second active-shape model.

2. The method of claim 1, wherein the step of (a) creating a first active-shape model of the portion comprises:
creating a first active-shape model of an endocardium at end-systole in an echocardiographic clip.

3. The method of claim 1, wherein the step of (a) creating a second active-shape model of the portion comprises:
creating a second active-shape model of an endocardium at end-diastole in an echocardiographic clip.

4. The method of claim 1, wherein the step of (c) generating a combined model for segmentation of the portion comprises:
computing \overline{c}(α)=α\overline{s}+(1−α)\overline{d}, 0≦α≦1.

5. The method of claim 1, wherein the step of (c) generating a combined model for segmentation of the portion comprises:
recovering a similarity transformation, wherein the similarity transformation projects the combined model to desired features of the clip.

6. The method of claim 5, further comprising:
(d) recovering a second linear combination of the modes of variation for the first active-shape model and the second active-shape model.

7. The method of claim 6, wherein the step of recovering a second linear combination comprises:
$$computing c ( α , {λ}_{k}^{d} , {λ}_{s}^{d} ) = \overline{c} ( α ) + {\sum }_{k = 1}^{{o}_{1}} {λ}_{k}^{d} ( {u}_{k}^{d} , {v}_{k}^{d} ) + {\sum }_{k = 1}^{{o}_{2}} {λ}_{k}^{s} ( {u}_{k}^{s} , {v}_{k}^{s} ) .$$

8. The method of claim 6, further comprising:
transforming the combined model using the similarity transformation;
deforming the transformed combined model using the second linear combination; and
segmenting the portion by aligning the deformed combined model to the desired features of the image.

9. The method of claim 1, further comprising:
repeating steps (a) through (c) for each frame in the clip.

10. The method of claim 1, further comprising:
acquiring the image using one of an ultrasound and a magnetic resonance device.

11. An apparatus for segmenting a portion of a clip, comprising the steps of:
a modeling means for creating a first active-shape model and a second active-shape model of the portion;
a first linear combination means for recovering a first linear combination of the first active-shape model and the second active-shape model;
a transformation means for recovering parameters of a similarity transformation between the first linear combination and a corresponding frame of the image;
a second linear combination means for recovering a second linear combination of the modes of variation for the first active-shape model and the second active-shape model; and
a segmentation means for determining a precise segmentation of the portion using the parameters of the similarity transformation and the second linear combination.

12. The apparatus of claim 1.1, wherein the first active-shape model comprises a first active-shape model of an endocardium at end-systole in an echocardiographic clip.

13. The apparatus of claim 11, wherein the second active-shape model comprises a second active-shape model of an endocardium at end-diastole in an echocardiographic clip.

14. The apparatus of claim 11, wherein the number of points in the first active-shape model equal the number of points in the second active-shape model.

15. The apparatus of claim 11, wherein the portion comprises a left ventricle.

16. The apparatus of claim 11, further comprising:
an acquisition means for acquiring the clip.

17. The apparatus of claim 16, wherein the acquisition means comprises an ultrasound device for acquiring an echocardiographic clip.

18. A program storage device readable by a machine, tangibly embodying a program of instructions executable on the machine to perform method steps for segmenting a portion of a clip, the method comprising the steps of:
(a) creating a first active-shape model of the portion in a first state;
(b) creating a second active-shape model of the portion in a second state; and
(c) generating a combined model for segmenting the portion, wherein the combined model is a linear combination of the first active-shape model and the second active-shape model.
